(19) United States
(12) Patent Application Publication
(10) Pub. No.: US 2007/0196622 A1
(43) Pub. Date: Aug. 23, 2007

(54) Patch with far infra red mineral particles

(76) Inventor: Yung-Zhen Chen, Tainan City (TW)

Correspondence Address: PHILLIP LIU, 6980, WHITEOAK DR., RICHMOND, BC, V7EAZ9, CA

(21) Appl. No.: 11/356,988

(22) Filed: Feb. 21, 2006

(51) Int. Cl. B32B 3/10

(52) U.S. Cl. 428/136; 428/137

(57) ABSTRACT

A patch includes a piece of fabric composed of far infra-red mineral particles and fibers of the piece of fabric. A treatment layer is attached on a side of the piece of fabric. The far infra-red mineral particles are evenly located in the piece of fabric and activate the cells of the user's skin and improve the blood circulation of the user to increase the amount of oxygen carried by the blood.

### FIELD OF THE INVENTION

The present invention relates to a patch including far infra-red mineral particles involved in the patch so as to activate the sells and improve the blood circulation.

### BACKGROUND OF THE INVENTION

A conventional patch 4 is shown in FIG. 1 and generally includes a piece of fabric 41 and a treatment layer 42 attached on a side of the piece of fabric 41. The treatment layer 42 is directly in contact with the user's skin 5 such that the treatment later 42 is functioned by the direct contact with the skin. The piece of the fabric 41 can be a soft woven or non-woven fabric and the treatment layer 42 is usually composed of several ingredients from plants, animals and/or minerals. Some treatment layers 42 includes chemical ingredients such as Mivacurium, steroid, or analgesic. The piece of fabric 41 performs as a carry media for the treatment layer 42 only and does not improve any function for the treatment layer 42 at all.

The present invention intends to provide a patch that involves far infra-red mineral particles which are ground into tiny particles and are combined with the fabric such that far infra-red mineral particles activate the cells of the user's skin and improve the blood circulation of the user to increase the amount of oxygen carried by the blood.

### SUMMARY OF THE INVENTION

The present invention relates to a patch which comprises a piece of fabric including of far infra-red mineral particles combined with fibers of the piece of fabric, and a treatment layer is attached on a side of the piece of fabric.

The primary object of the present invention is to provide a patch with a treatment layer wherein the far infra-red mineral particles in the piece of fabric of the patch improves the condition of the user's skin to absorb the treatment effectively.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional patch on a user's skin;

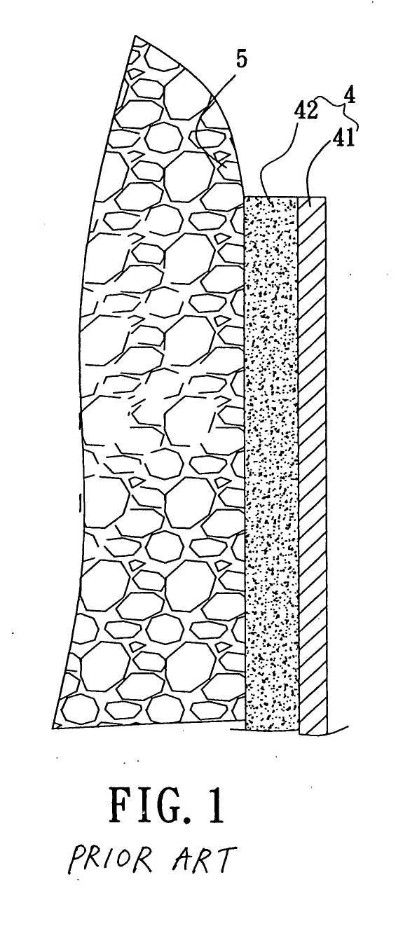

FIG. 2 is a cross sectional view to show the patch of the present invention on a user's skin;

FIG. 3 illustrates the components of the patch of the present invention, and

FIG. 4 shows that the patch is in a form of a facial mask.

### DETAILED DESCRIPTION OF THE PREFERRED EMBODIMENT

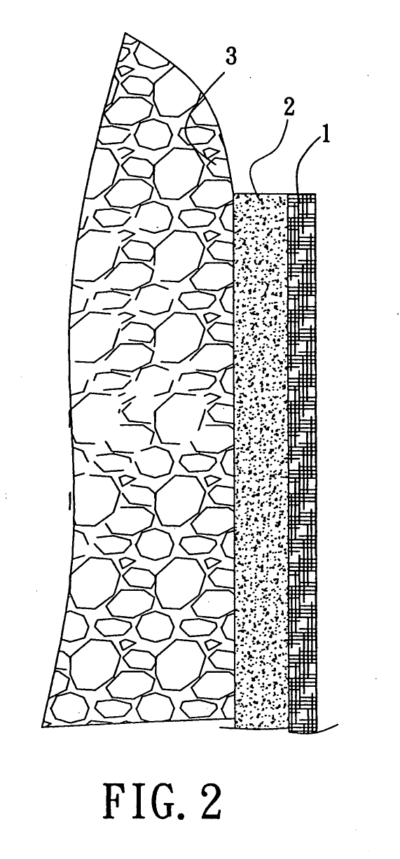

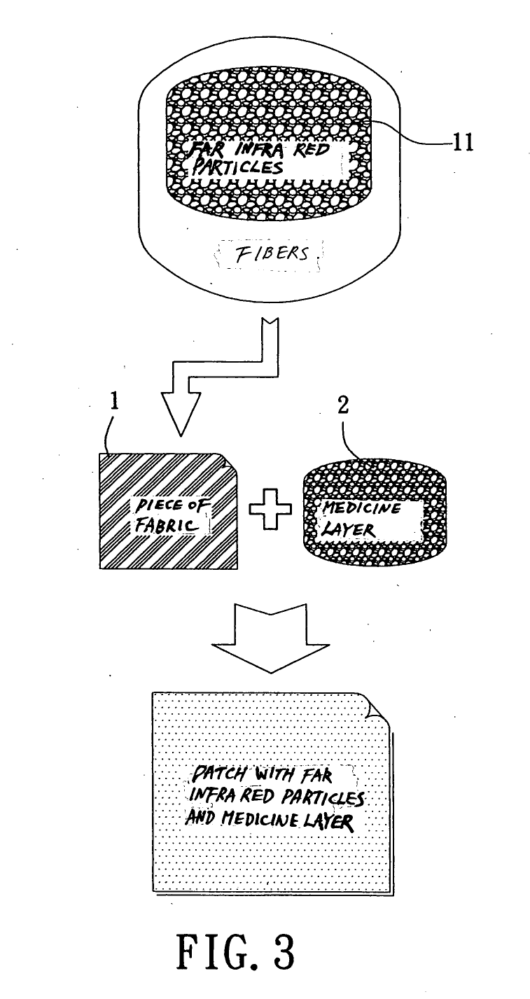

Referring to FIGS. 2 and 3, the patch of the present invention comprises a piece of fabric 1 including of far infra-red mineral particles 11 combined with fibers of the piece of fabric 1. A treatment layer 2 is attached on a side of the piece of fabric 1. The far infra-red mineral particles 11 are ground into 30 to 40 nm and combined with the fibers of the piece of fabric 1. The piece of fabric 1 can be a woven fabric or non-woven fabric.

The treatment layer 2 is directly attached on the user's skin 3 and the ingredients of the treatment layer 2 are then absorbed by cells of the skin 3. It is noted that the far infra-red mineral particles are evenly located in the piece of fabric 1 and activate the cells of the user's skin and improve the blood circulation of the user to increase the amount of oxygen carried by the blood.

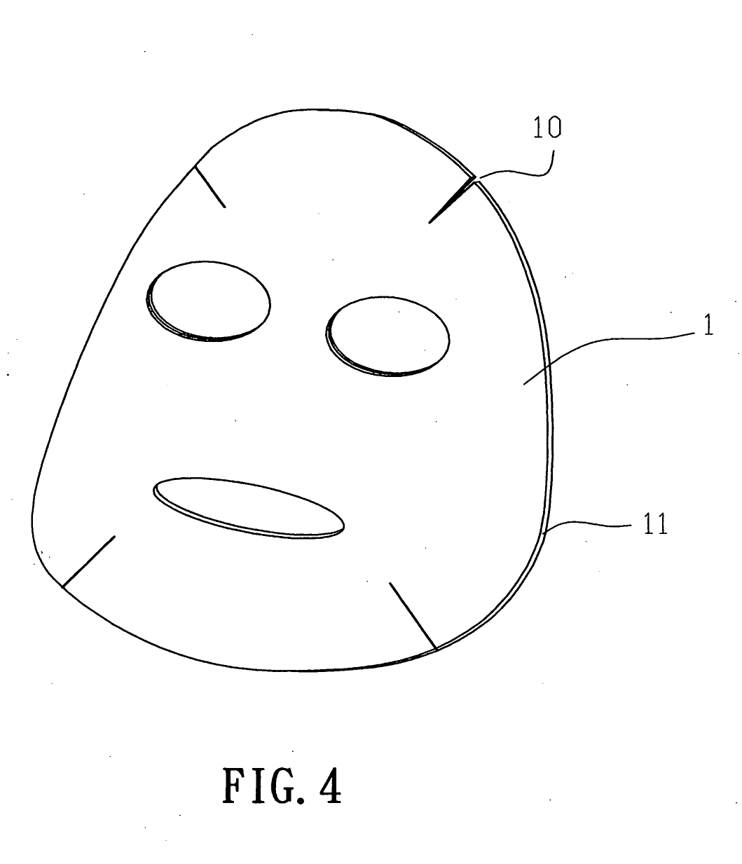

FIG. 4 shows that the patch can be made in a form of a facial mask which includes three holes for the user's eyes and nose not to be covered by the mask. Several slits are cut along the periphery of the mask so as to fit the contour of user's face.

While we have shown and described the embodiment in accordance with the present invention, it should be clear to those skilled in the art that further embodiments may be made without departing from the scope of the present invention.

What is claimed is:

1. A patch comprising:
a piece of fabric including of far infra-red mineral particles combined with fibers of the piece of fabric.

2. The patch as claimed in claim 1, wherein a treatment layer is attached on a side of the piece of fabric.

3. The patch as claimed in claim 1, wherein the patch includes a plurality of holes defined therethrough.

4. The patch as claimed in claim 1, wherein a plurality of slits are cut along a periphery of the patch.
